(19) United States
(12) Patent Application Publication
(10) Pub. No.: US 2012/0216459 A1
(43) Pub. Date: Aug. 30, 2012

(54) METHOD AND APPARATUS FOR OPTIMAL ENRICHMENT OF CO2 FOR PLANT PRODUCTION

(76) Inventor: DAVID FREDERICK CURRIER, Berkley, MI (US)

(21) Appl. No.: 13/370,582

(22) Filed: Feb. 10, 2012

Related U.S. Application Data
(60) Provisional application No. 61/464,048, filed on Feb. 28, 2011.

(51) Int. Cl. A01G 7/02

(52) U.S. Cl. 47/58.1 R; 47/1.1 R

(57) ABSTRACT

The invention provides a method for optimal CO2 enrichment for plant production by suspending CO2 tubing in a secured position between both the plant canopy and lighting system within an indoor garden. The method provides for CO2 tubing to be secured to the lighting system of an indoor garden, thus allowing for the CO2 to be evenly dispersed directly over the optimal upper third portion of the plant canopy. By securing the CO2 tubing in the optimal distribution point, the invention also provides a method for users of the CO2 tank “timed release” system of CO2 enrichment to maximize the amount of CO2 over the upper third portion of the plant canopy during the limited time it is released in the indoor garden during the “lights on” portion of the grow cycle. The invention also provides an apparatus for carrying out the method.

### PROVISIONAL PATENT APPLICATION

U.S. 61/464,048

### FEDERALLY SPONSORED RESEARCH

Not Applicable

### SEQUENCE LISTING OR PROGRAM

Not Applicable

### BACKGROUND OF THE INVENTION

When CO2 levels are between 1000 and 1500 PPM, plants consume more light energy, base nutrients, water and oxygen to create a maximum rate of photosynthetic activity. This maximum rate of photosynthetic activity results in the astonishing plant yields all indoor gardeners strive for. The major hurdle in achieving this goal is the fact that the average level of CO2 in the air is merely 300 PPM. Plants are composed of 80-90% carbon and water, while most of the carbon in plants comes from the minimal 300 PPM level of CO2 in the air. While the indoor gardening industry has experienced amazing advances in lighting, nutrients, pest control, cloning and hydroponics, the limiting factor in maximizing the potential of an indoor garden is the amount (and lack of) available CO2 in the grow room's climate.

Carbon dioxide is one of the three main components which form to create the products needed for plant growth, but the level of CO2 in the air is only 0.03%. This compares to 78% Nitrogen, 21% Oxygen and 0.97% trace gases in normal air.

At such a low level of 300 PPM in the air, plants can easily consume all of the CO2 in an indoor garden in a matter of hours. Plants are only able to produce up to the limited amount of CO2 available, and once CO2 levels are 200 PPM or lower photosynthetic activity will diminish and eventually stop altogether.

When the CO2 supply in an indoor garden ceases to exist, so does photosynthesis. The process of photosynthesis mixes CO2 and water to produce sugars and free oxygen. Photosynthesis occurs only in the presences of light and is therefore useless, and even harmful to enrich the plants with CO2 during the dark (lights off) period of plant production.

For decades, biologists and plant physiologists have recognized the dividends paid by enriching the climate of an indoor garden with increased levels of CO2. The indoor gardening industry is expanding as each month passes, resulting in thousands of new growers reaping the myriad of benefits of introducing CO2 enrichment methods into their indoor garden.

Research has shown that increasing CO2 will increase plant size, yield, vigor and speed up growth. Plants grown with increased levels of CO2 are also less prone to common insect and disease issues. By increasing CO2 levels to 1000-1500 PPM during the lights on period, research has shown CO2 enrichment can increase yields 25-50%. A CO2 concentration greater than 1500 PPM may cause partial or complete closure of the plant stomas (tiny openings in the plant leaf), which is a vital component for photosynthesis.

CO2 is heavier than air; at 77 degrees, CO2 weighs 66 ounces per 3 cubic feet, while air weighs 42 ounces per 3 cubic feet at the same temperature. Aside from being heavier than air, CO2 moves slowly downward from its distribution point and only travels a short distance through the diffusion process.

When implementing CO2 enrichment methods, careful planning and positioning of equipment is crucial to ensure the dispersed CO2 is directed toward the plant zone so it can be absorbed by the plants at a maximum capacity. Studies have proven that CO2 enrichment should take place in the upper third part of the plant canopy where photosynthetic activity is at its peak. Plants will also consume all of the available CO2 around their leaves within minutes. Thus, a need exists for a method and apparatus that would disperse CO2 from the optimal distribution point directly above the plant canopy.

While some indoor gardeners choose forms of CO2 enrichment such as dry ice, fermentation and decomposition of organic matter, the two most commonly used forms of CO2 enrichment are combustion generators and compressed CO2 tanks.

Carbon dioxide generators are industrial units that burn fuel to produce CO2. As a result of the high amount of excess heat put out by these units, they are only suggested for indoor gardens or greenhouse operations larger than 1000 cubic feet. To avoid the increased temperature issues that coincide with carbon dioxide generators, many indoor gardeners elect to use a compressed CO2 tank and regulator as their form of CO2 enrichment.

Compressed CO2 comes in metal containers under high pressure with pressure ranges from 1600 pounds per square inch to 2200 PSI. This form of enrichment is referred to as a “timed release” system that releases a certain amount of compressed carbon dioxide from a tank at a timed rate of release. When choosing this “timed release” system, one will need to purchase a compressed CO2 tank (20 or 50 lb.), tank regulator and a timer. The regulator controls the quantity of CO2 emitted into the indoor garden atmosphere, while the timer controls precisely when and for how long the CO2 is released.

The average growing area enriched to 1500 PPM of CO2 will return to normal levels (300 PPM) in about 3 hours due to plant usage and room leakage. When selecting a CO2 release interval of every 3 hours, a grower must then calculate how long to release CO2 every 3 hours to keep the CO2 at the desired 1500 PPM level during the “lights on” period. To accomplish this, indoor gardeners will use the following formula (cubic feet X 0.0012) to precisely raise PPM levels from 300 to 1500. Using the model of a 10×10×8 growing area, the calculations will be as follows . . .

800×0.0012=0.96 CFM needed

Tank regulator set to 20 CFH (0.33 CFM)

CO2 will need to be released for 3 minutes every hour to reach 1500 PPM

With the time release interval of every 3 hours, CO2 will need to be dispersed for merely 9 minutes every 3 hours to keep CO2 levels at 1500 PPM. Thus, it would be desirable to have a method and apparatus to ensure that the CO2 is being maximized during the limited amount of time that it is being dispersed.

When using the CO2 tank system, vinyl tubing is attached to the tank regulator and positioned in the indoor garden for dispersing the CO2. This tubing is referred to as “drilled” CO2 tubing, where the CO2 is vaporized through small holes in the tubing and homogenously dispersed throughout the indoor garden.

Currently, the preferred method of arranging the CO2 tubing in an indoor garden is by suspending a circular “distribution ring” of CO2 tubing from the ceiling that does not interfere with the lighting. With the labyrinth of cords and light hanging kits already suspended from the ceiling in an indoor garden, it becomes a difficult and time consuming task to properly construct this circular “distribution ring” of CO2 tubing.

Also, the lights in an indoor garden need to be raised and lowered at various times throughout the growing cycle to accommodate the constantly changing plant heights, making it a daunting task to secure this “distribution ring” in a manner that does interfere with the lighting. As a result, it would be an improvement to have a method and apparatus that would arrange the CO2 tubing in a manner where the CO2 would be dispersed from a distribution point located between both the plant canopy and the lighting system.

It is known that for optimal CO2 enrichment, the CO2 should be evenly dispersed over the upper third portion of the plant canopy, but you are unable to accomplish this goal of optimal enrichment using the current “distribution ring” method of arranging CO2 tubing.

Even if the “distribution ring” is constructed and secured in the preferred circular manner over the growing area, the lights and ventilation system suspended over the plant canopy prevent the CO2 from being evenly dispersed over the desired upper third portion of the plant canopy. Thus, a need exists for a method and apparatus allowing for CO2 to be evenly dispersed from CO2 tubing from a distribution point that is directly above the plant canopy.

If plants are currently growing in the indoor garden, it is not possible to construct and secure the “distribution ring” in the preferred circular manner without stressing the plants. In such situations, it would also be desirable to have a method and apparatus for dispersing CO2 directly above the plant canopy that could easily be arranged and secured without stressing plants that are currently growing in the indoor garden.

Many indoor gardens are designed with the lights separated into two sections on opposite sides of the room, creating an aisle for growers to have increased access to their plants. In such situations, the preferred method of the “distribution ring” is even less effective since only a small percentage of the CO2 tubing will be suspended over the plant canopy. As a result, there is a need for a method and apparatus that would evenly disperse CO2 from a distribution point directly above the optimal upper third portion of the plant canopy, regardless of the design and layout of the indoor garden.

### FIELD OF THE INVENTION

The present invention relates generally to indoor plant production and more particularly, the invention relates to a method and apparatus allowing for CO2 to be dispersed from the optimal distribution point above the plant canopy.

### DETAILED DESCRIPTION OF THE INVENTION

The present invention provides CO2 to be dispersed from CO2 tubing at the optimal distribution point directly above the plant canopy for plant production.

The present invention provides for CO2 tubing to be secured in a location between both the plant canopy and the lighting system within an indoor garden. Since it is known that CO2 is heavier than air, the present invention will have a various number of openings in the bottom of the apparatus, thus allowing the CO2 to be evenly dispersed directly over the optimal upper third portion of the plant canopy.

While the CO2 tank system is the safest form of CO2 enrichment for indoor gardens, it is also the most expensive. Average CO2 cost is 0.50 cents per pound at most supply houses, and removing the heavy tanks from the indoor garden and having them refilled at welding supply stores is a chore that every user of the CO2 tank system hopes to do as few times as possible throughout each growing cycle.

Few indoor gardeners actually achieve the goal of having a 100% sealed room, thus losing a % of the pricey CO2 each time the CO2 is dispersed throughout the “lights on” portion of the grow cycle. The present invention provides a method and apparatus that keeps the maximum amount of CO2 in the optimal upper third portion of the plant canopy, thus minimizing the amount of CO2 lost as a result of leakage in the indoor garden.

The average indoor garden is already cluttered with lights, light hanging kits and ventilation being suspended from the ceiling, resulting in setting up the currently preferred “distribution ring” method of securing CO2 tubing to be a highly difficult undertaking, and a method that is not possible without stressing plants that are currently growing. The present invention provides a method and apparatus for suspending CO2 tubing at the optimal distribution point that can be secured to any reflector (steel, aluminum, etc.) quickly, cleanly and does so in a manner that would not stress any plants that are currently growing.

No two indoor gardens are identical, as growers are constantly altering the design and layout of their indoor gardens striving for the maximum yield possible. While it is known that plants will consume all of the available CO2 around their leaves within minutes, the present invention provides a method and apparatus securing CO2 tubing in the optimal distribution point allowing for CO2 to be readily available for consumption by the plant, regardless of the design and layout of the indoor garden. Whether it is a small indoor garden with 4 lights, or a large commercial greenhouse with 40 lights, the present invention provides a method and apparatus allowing for the CO2 tubing on all of the lights to be secured in the optimal distribution point and connected to each other through the use of “barbed tee connectors” for the CO2 tubing.

In order to achieve the maximum yield possible, indoor gardeners must enrich the climate of their indoor garden with increased levels of CO2. Optimal photosynthesis can be achieved within an indoor garden, but only in the presence of optimal CO2 enrichment. By allowing for CO2 tubing to be secured in a distribution point that will disperse CO2 evenly and directly over the upper third portion of the plant canopy, the present invention provides a method and apparatus for optimal enrichment of CO2 levels for indoor garden plant production.

### BRIEF DESCRIPTION OF THE FIGURES

The drawings constitute a part of the specification and include exemplary embodiments to the invention, which may be embodied in various forms. It is to be understood that in some instances various aspects of the invention may be shown exaggerated or enlarged to facilitate an understanding of the invention.

FIG. 1 is a top perspective view of an apparatus according to the invention.

FIG. 2 is a bottom perspective view of an apparatus according to the invention.

FIG. 3 is a bottom perspective view of the method and apparatus according to the invention.

### DETAILED DESCRIPTION OF THE PREFERRED EMBODIMENTS

Detailed descriptions of the preferred embodiment are provided herein, it is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

Referring to the drawings, the present invention will now be described in detail with reference to the disclosed embodiment.

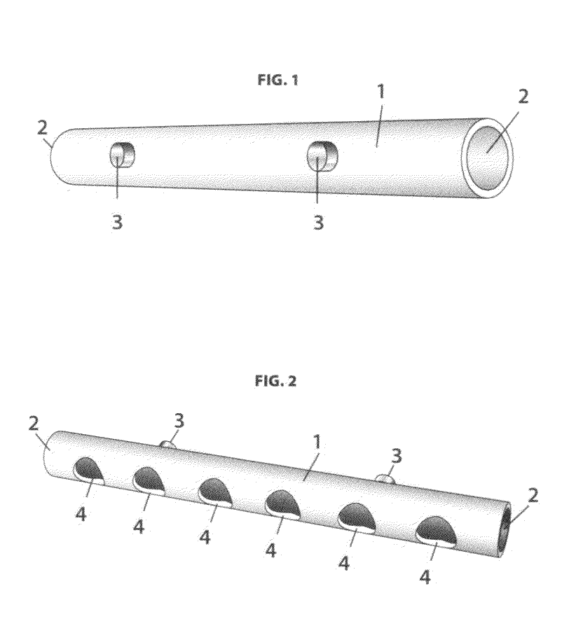

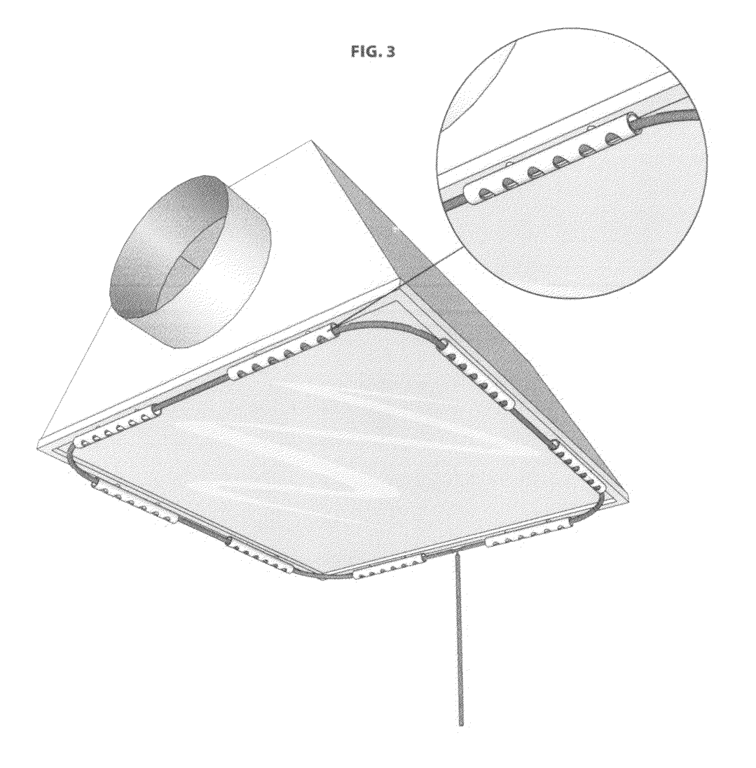

FIGS. 1-2 show the apparatus 1 for securing CO2 tubing in the optimal distribution point. In the preferred embodiment, the apparatus 1 would be made of extruded clear polycarbonate tubing.

One of the features of the invention in the preferred embodiment is to have openings 2 at each end of the apparatus 1, thus allowing for multiple pieces to be connected to each other.

Also, the invention in the preferred embodiment will have openings 4 in the bottom of the apparatus 1, thus allowing for CO2 to drop through the openings 4 and be evenly dispersed over the upper third portion of the plant canopy.

An additional feature of the invention in the preferred embodiment will be adhesive pieces 3 on the top of the apparatus 1, thus allowing for the apparatus 1 to be secured to the lighting system in an indoor garden. The adhesive pieces 3 will be made with materials allowing for the apparatus 1 to be neatly and easily attached to the lighting system without stressing plants that may be currently growing.

FIG.3 shows the method according to the present invention, allowing for CO2 tubing to be neatly secured around the perimeter of the lighting system in an indoor garden. By using multiple pieces of the apparatus on each side of the lighting system, CO2 tubing will be secured in the optimal distribution point between both the plant canopy and the lighting system. By securing CO2 tubing in the optimal distribution point, the method will use multiple pieces of the apparatus 1, allowing for CO2 to be evenly dispersed above the plant canopy.

One of the features of the method according to the present invention is the fact that by using “barbed tee connectors,” the method can neatly and easily be connected to the CO2 tank needed for this form of CO2 enrichment in an indoor garden. Also, by using “barbed tee connectors” the method can neatly and easily be connected to other lights in the indoor garden, regardless of how many lights may exist.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims. The scope is to be accorded the broadest interpretation so as to encompass all such modifications and equivalent structures as is permitted under the law.

1. A method for optimal CO2 enrichment for plant production by suspending CO2 tubing in a secured position between both the plant canopy and the lighting system within an indoor garden.

2. A method according to claim 1, allowing for released CO2 to be evenly dispersed directly above the desired the upper third portion of the plant canopy within in an indoor garden.

3. A method according to claim 1, in which the maximum amount of released CO2 will be released above the optimal upper third portion of the plant canopy, thus allowing for the full potential of CO2 enrichment within an indoor garden to be achieved.

4. A method according to claim 1, allowing for the released CO2 to be evenly dispersed from a distribution point directly above of the optimal upper third portion of the plant canopy, regardless of the design and layout of the indoor garden.

5. A method according to claim 1, that can be attached to the lighting system within an indoor garden quickly, cleanly and does so in a manner that will avoid damaging or stressing plants that may be currently growing within the indoor garden.

6. A method according to claim 1, in which an unlimited number of lights within an indoor garden can be connected to each other using “barbed connectors” for the CO2 tubing.

7. An apparatus for suspending CO2 tubing in a secured position, thus allowing for CO2 to be released directly over the plant canopy once the CO2 is dispersed through the small holes in the CO2 tubing.

8. An apparatus according to claim 7, in which the diameter is at least large enough to secure ¼ inch CO2 tubing.

9. An apparatus according to claim 7, which has openings in the bottom that allow for CO2 to drop directly over the plant canopy once it is dispersed through the small holes in the CO2 tubing.

10. An apparatus according to claim 7, which has adhesive on the top, thus allowing it to be secured to the lighting system within an indoor garden.
